(19) United States
(12) Patent Application Publication
(10) Pub. No.: US 2024/0381908 A1
(43) Pub. Date: Nov. 21, 2024

(54) Food Processor

(71) Applicant: Season Agricultural Technology Co., Ltd., Tainan City (TW)

(72) Inventor: Ching-Chieh Yang, Tainan City (TW)

(21) Appl. No.: 18/318,012

(22) Filed: May 16, 2023

(51) Int. Cl. A23L 3/36

(52) U.S. Cl. CPC A23L 3/363

(57) ABSTRACT

A food processor (100) includes a cooling device (10) including a box (11). The box has a cooling space (111). The cooling space has an inner peripheral wall (113) made of graphene steel material. The graphene steel material of the inner peripheral wall of the cooling space includes steel and graphene which are mixed. Thus, the graphene effectively inhibits growth of the ice crystals, to prevent the cell membrane and cell wall from being damaged. In addition, the graphene maintains the nutrition, aroma and weight of the foodstuff when thawing.

### BACKGROUND OF THE INVENTION

### Field of the Invention

The present invention relates to a food processor or freezer or freezing apparatus and, more particularly, to a food processor for processing foodstuff.

### Description of the Related Art

At present, a method for preserving foodstuff mainly uses rapid freezing to prolong the expiration date of the foodstuff. However, moisture or water molecules contained in the food ingredients will produce ice crystals during the rapid freezing process, which causes the volume of the food ingredients to expand, which will destroy the cell membranes of the food ingredients, resulting in a loss of the cell contents in the food ingredients during thawing, so that the nutrition, aroma and weight of the food ingredients will be reduced. A conventional freezing apparatus was disclosed in the U.S. Pat. No. 7,237,400B2, and comprises a freezing box and a plurality of magnetic field generating devices mounted in the freezing box. In practice, the magnetic field generating devices are used to generate electromagnetic waves which are used to slow down formation of the ice crystals, thereby maintaining the quality of the food ingredients. However, the conventional freezing apparatus has a complicated construction with an expensive price, thereby greatly increasing the cost of fabrication and production.

### BRIEF SUMMARY OF THE INVENTION

In accordance with the present invention, there is provided a food processor comprising a cooling device including a box. The box has a cooling space. The cooling space has an inner peripheral wall made of graphene steel material. The graphene steel material of the inner peripheral wall of the cooling space includes steel and graphene which are mixed.

According to the primary advantages of the present invention, the graphene effectively inhibits growth of the ice crystals, to prevent the cell membrane and cell wall from being damaged. In addition, the graphene maintains the nutrition, aroma and weight of the foodstuff when thawing. Further, the cost of fabrication is reduced. Further, the surface of the graphene material has a uniform honeycomb crystal lattice with a strong bonding force, to prevent the molecules on the surface of the graphene from attracting the hydrogen bonds in the water molecules, so that the graphene material has a high hydrophobic property, and the water molecules cannot form an ice crystal structure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a food processor in accordance with the first preferred embodiment of the present invention.

FIG. 2 is a perspective view of a food processor in accordance with the second preferred embodiment of the present invention.

### DETAILED DESCRIPTION OF THE INVENTION

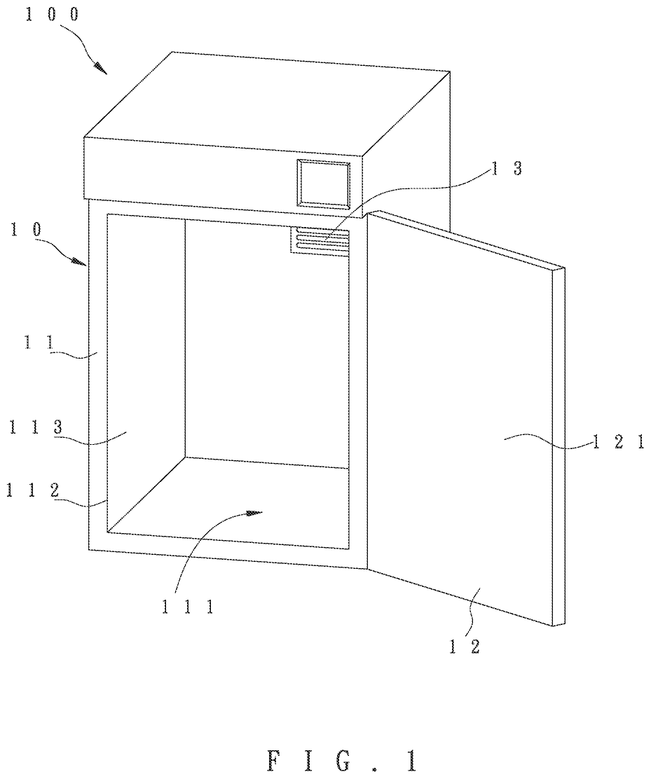

Referring to the drawings and initially to FIG. 1, a food processor 100 in accordance with the first preferred embodiment of the present invention comprises a cooling device 10. The cooling device 10 includes a box 11, a door 12, and a condenser 13. The box 11 has a cooling space 111 and an opening 112 connecting the cooling space 111 to an ambient environment. The cooling space 111 has an inner peripheral wall 113 made of graphene steel material. The graphene steel material of the inner peripheral wall 113 of the cooling space 111 includes steel and graphene which are mixed. The graphene steel material of the inner peripheral wall 113 of the cooling space 111 has a volume ratio, with the steel in a proportion of 90% to 95%, and with the graphene in a proportion of 10% to 5%. Preferably, the steel has an optimum proportion of more than 95%, and the graphene has an optimum proportion of less than 5%. The door 12 is pivotally connected to the box 11, and is pivoted reciprocally between a closed position and an opened position. When the door 12 is disposed at the closed position, the opening 112 is closed by the door 12, and when the door 12 is disposed at the opened position, the opening 112 is opened. The condenser 13 is mounted on the box 11 to cool the cooling space 111.

When foodstuff is placed in the cooling space 111, the foodstuff is cooled to lower its temperature. At the same time, water molecules contained in the foodstuff are affected by the graphene of the inner peripheral wall 113 so that the shape of ice crystals is modified to effectively inhibit growth of the ice crystals and generation of recrystallization. In addition, the graphene and the solid ice form a steady hydrogen bond which is selectively adsorbed to the surface of the ice crystals in the presence of a large amount of liquid water, and forms a curved surface on the ice crystals, to inhibit the growth of the ice crystals through the Gibbs-Thomson effect.

Thus, the graphene of the inner peripheral wall 113 is able to reduce the ice crystals produced by the water molecules contained in the foodstuff during the cooling and freezing process to prevent the cell membrane and cell wall from being damaged. In addition, the graphene of the inner peripheral wall 113 is able to maintain the nutrition, aroma and weight of the foodstuff when thawing. Besides, the food processor 100 has a simplified structure with simple parts to decrease the cost of fabrication.

In addition, hydrophilic or hydrophobic property of a material depends on whether the molecules on the surface of the material and the hydrogen bonds in the water molecules will attract each other due to polarization. The surface of the graphene material has a uniform honeycomb crystal lattice with a strong bonding force, so that the molecules on the surface of the graphene will not attract the hydrogen bonds in the water molecules. Thus, the graphene material has a high hydrophobic property, so that the water molecules cannot form an ice crystal structure.

In the preferred embodiment of the present invention, the door 12 has an inner wall 121 made of graphene steel material. The graphene steel material of the inner wall 121 of the door 12 includes steel and graphene which are mixed. The graphene steel material of the inner wall 121 of the door 12 has a volume ratio, with the steel in a proportion of 90% to 95%, and with the graphene in a proportion of 10% to 5%. Preferably, the steel has an optimum proportion of more than 95%, and the graphene has an optimum proportion of less than 5%.

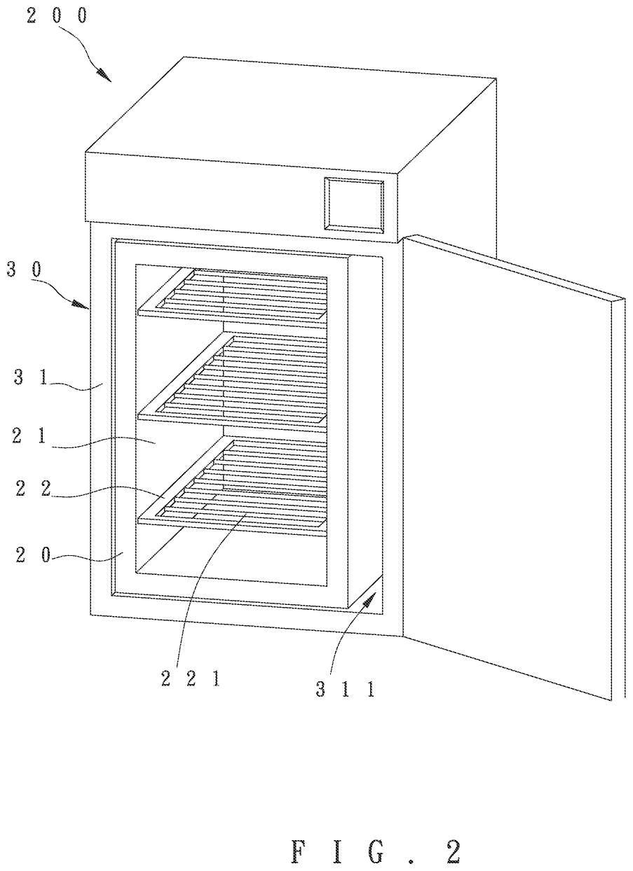

Referring to FIG. 2, a food processor 200 in accordance with the first preferred embodiment of the present invention comprises a cooling device 30 and a support rack 20. The cooling device 30 includes a box 31. The box 31 has a cooling space 311. The support rack 20 is mounted in the cooling space 311 of the box 31 of the cooling device 30 for placing the foodstuff. The support rack 20 has an inner peripheral wall 21 made of graphene steel material. The graphene steel material of the inner peripheral wall 21 of the support rack 20 includes steel and graphene which are mixed. The graphene steel material of the inner peripheral wall 21 of the support rack 20 has a volume ratio, with the steel in a proportion of 90% to 95%, and with the graphene in a proportion of 10% to 5%. Preferably, the steel has an optimum proportion of more than 95%, and the graphene has an optimum proportion of less than 5%. Thus, the graphene material reduces generation of the ice crystals.

The support rack 20 includes at least one shelf 22 having multiple steel tubes 221 juxtaposed to each other. Each of the steel tubes 221 is made of graphene steel material. The graphene steel material of each of the steel tubes 221 includes steel and graphene which are mixed. The graphene steel material of each of the steel tubes 221 has a volume ratio, with the steel in a proportion of 90% to 95%, and with the graphene in a proportion of 10% to 5%. Preferably, the steel has an optimum proportion of more than 95%, and the graphene has an optimum proportion of less than 5%.

Thus, the box 31 has a conventional structure without needing additional design and production, thereby decreasing the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A food processor (100) comprising:
a cooling device (10) including a box (11);
wherein:
the box has a cooling space (111);
the cooling space has an inner peripheral wall (113) made of graphene steel material; and
the graphene steel material of the inner peripheral wall of the cooling space includes steel and graphene which are mixed.

2. The food processor as claimed in claim 1, wherein the graphene steel material of the inner peripheral wall of the cooling space has a volume ratio, with the steel in a proportion more than 95%, and with the graphene in a proportion less than 5%.

3. The food processor as claimed in claim 1, wherein:
the cooling device further includes a door (12);
the box has an opening (112) connecting the cooling space to an ambient environment;
the door is pivotally connected to the box, and is pivoted reciprocally between a closed position and an opened position;
when the door is disposed at the closed position, the opening is closed by the door, and when the door is disposed at the opened position, the opening is opened;
the door has an inner wall (121) made of graphene steel material; and
the graphene steel material of the inner wall of the door includes steel and graphene which are mixed.

4. The food processor as claimed in claim 3, wherein the graphene steel material of the inner wall of the door has a volume ratio, with the steel in a proportion more than 95%, and with the graphene in a proportion less than 5%.

5. The food processor as claimed in claim 1, wherein the cooling device further includes a condenser (13) mounted on the box to cool the cooling space.

6. A food processor (200) comprising:
a cooling device (30) and a support rack (20);
wherein:
the cooling device includes a box (31) and a door;
the box has a cooling space (311) and an opening connecting the cooling space to an ambient environment;
the door is pivotally connected to the box, and is pivoted reciprocally between a closed position and an opened position;
when the door is disposed at the closed position, the opening is closed by the door, and when the door is disposed at the opened position, the opening is opened;
the support rack is mounted in the cooling space of the box of the cooling device; and
the support rack has an inner peripheral wall (21) made of graphene steel material.

7. The food processor as claimed in claim 6, wherein the graphene steel material of the inner peripheral wall of the support rack includes steel and graphene which are mixed, and has a volume ratio, with the steel in a proportion more than 95%, and with the graphene in a proportion less than 5%.

8. The food processor as claimed in claim 6, wherein the cooling device further includes a condenser mounted on the box to cool the cooling space.

9. A food processor (200) comprising:
a cooling device (30) and a support rack (20);
wherein:
the cooling device includes a box (31) and a door;
the box has a cooling space (311) and an opening connecting the cooling space to an ambient environment;
the door is pivotally connected to the box, and is pivoted reciprocally between a closed position and an opened position;
when the door is disposed at the closed position, the opening is closed by the door, and when the door is disposed at the opened position, the opening is opened;
the support rack is mounted in the cooling space of the box of the cooling device;
the support rack includes at least one shelf (22) having multiple steel tubes (221); and
each of the steel tubes is made of graphene steel material.

10. The food processor as claimed in claim 9, wherein the graphene steel material of each of the steel tubes includes steel and graphene which are mixed, and has a volume ratio, with the steel in a proportion more than 95%, and with the graphene in a proportion less than 5%.
